(19) United States
(12) Patent Application Publication
(10) Pub. No.: US 2005/0071174 A1
(43) Pub. Date: Mar. 31, 2005

(54) Method and system for valuing intellectual property

(76) Inventors: Mark Harold Leibowitz, Somerset West (ZA); Christopher John Seebregts, Westlake (ZA); Mark Harold Leibowitz, Somerset West (ZA)

Correspondence Address: Richard J Steit;Ladas & Parry, 224 South Michigan Avenue, Suite 1200, Chicago, IL, 60604, US

(21) Appl. No.: 10/485,432

(22) PCT Filed: Jul. 31, 2002
(86) PCT No.: PCT/IB02/02958

(30) Foreign Application Priority Data
Jul. 31, 2001 (ZA) 2001/6302

(51) Int. Cl. G06F 17/60; G06G 7/00

(52) U.S. Cl. 705/1; 705/400

(57) ABSTRACT

An automated system and method for determining the value of an intangible asset or intellectual property and developing a fair remuneration structure for licensing or purchasing the intangible asset or intellectual property by comparison to a dissected database of prior licensing and sale transactions. Valuation determinants and remuneration structures from prior transactions are extracted, analyzed and weighted and loaded into a knowledge base. Remuneration structures are normalized and used to train predictive algorithms based on a market analysis of previous transactions. The algorithms are able both to learn from previous transactions and to assess the importance of particular valuation determinants in determining the value under particular circumstances. An equitable rate for a new transaction is determined by examining the knowledge base and varying the valuation determinants. An optional expert system and dynamic modeling environment are provided.

### BACKGROUND OF THE INVENTION

THIS invention relates to the valuation of intangible assets, including intellectual property, more particularly to an automated system that predicts a fair rate for the sale or licensing of an intellectual property or intangible asset based predominantly on a market assessment of other transactions.

The invention relates generally to the field of royalty rate and license fee determination and intangible asset and intellectual property valuation. More specifically, the invention relates to a method and computer-implemented system for accurately determining license fees and royalty rates and for valuing intellectual property.

Many organisations and individuals need to calculate license fees and royalty rates or perform intellectual property valuations. Lawyers and accountants need to calculate license fees and royalty rates and value intellectual property in drawing up certain documents and calculating the asset structure of a company. Banks need to be able to value intellectual property as part of organisational intangible assets in order to better calculate net worth and establish lending risk, and thus rate, and borrowing power. Insurers need to perform valuations in order to calculate actuarial values for coverage.

A significant amount of skill and effort is required to research and gather the required background information and accurately calculate license fees and royalty rates and value intellectual property. In general, heavy reliance is mad on valuation professionals with direct knowledge of the specific area of application and, sometimes, valuations are simply loose estimates based on heuristics particularly where there is insufficient knowledge of the application domain. The process is complicated by the fact that a particular valuation is often inextricably linked to the organisation or industry in which it appears and the fact that expert understanding of a particular industry is required to perform a fair valuation.

There are three generally accepted valuation approaches. The cost approach quantifies the replacement cost of future service capability; the income approach quantifies the income producing capability and the market approach bases the estimation on a consensus of what others perceive the value to be, as indicated by arms length transactions in a free market. Although the market approach is the most direct and easily understood valuation method, it is seldom used as it requires, among others, an active public market and exchange of comparable intangible assets or intellectual property in the same or very similar area of application and these are seldom known (or existent).

Valuators often spend a significant amount of time and effort gleaning data from financial statements which, while providing a consistent and reliable framework from which to work, are also unreliable predictors of value. This is mainly because financial statements are generally skewed heavily or exclusively in favor of tangible assets and therefore are unreliable predictors of intangible asset or intellectual property value. In the absence of a counterbalancing force, as in an arms length business negotiation process, appraiser bias may also skew a particular valuation in one or other direction, depending on the purpose for which the valuation will be used.

Several companies sell books, professional journals, access to electronic databases, information retrieval or alerting services and software systems, that include algorithmic estimation and modeling applications, to assist with license fee and royalty rate determination and with intellectual property valuation. These are generally based on the cost or income approach. Much of the information regarding licensing transactions is publicly available and, in addition, many organizations maintain private licensing transaction databases.

At present, valuators mostly use the income approach to intellectual property valuation and require an extensive information gathering effort before the valuation can be performed. This is expensive, time-consuming and requires specialist skills. Although databases of transaction information do exist, they are generally used as repositories of information and not as the basis for artificial intelligence (AI) techniques such as artificial neural networks, concept matching or expert system analysis. On account of the fact that transaction information is largely incomparable, valuations based on prior transactions are rare, and legal precedents of little value. In addition, there are few valuation standards or generally accepted procedures that result in an objective assessment. As a result, valuations are often the result of a business negotiation process and not necessarily based on an understanding of the actual market value. This issue is increasingly becoming the norm as a result of the emergence of organisations whose main (or even sole) value is in intellectual property, with the consequent increased requirement for licensing transactions and payment of royalties. Information age managers are increasingly becoming aware of the shortfalls of conventional methods for performing valuations and increasingly require techniques that are able to effectively value intangible assets and intellectual property.

It is an object of the invention to provide an automated method and system for accurately determining license fees and royalty rates and for valuing intangible assets, and particularly intellectual property.

### SUMMARY OF THE INVENTION

According to the invention there is provided a method of valuing intellectual property, the method comprising:
compiling a first, transaction database of transaction data corresponding to a plurality of transactions relating to intellectual property;
normalizing the remuneration structure of specific transactions in order to extract normalized values thereof and storing said values in a second, market value database;
dissecting and analysing the transaction data according to a predetermined scheme and storing the dissected and analysed data in a third, determinants database;
evaluating the importance of selected determinants according to predetermined criteria to obtain ratings and weightings corresponding thereto, and storing the ratings and weightings in a fourth, ratings and weightings database;
compiling an artificial neural network knowledgebase using information from the ratings and weightings database and other inputs;
extracting financial and market data from the transaction data and storing the extracted financial and market data in a fifth, financial database;
comparing stored data from the second, third, fourth and fifth databases and the artificial neural network knowledgebase with current transaction data, current market value data, and current financial and market data relating to a transaction under consideration, according to predetermined criteria, to identify similarities between the stored data and the said current data, thereby to generate an initial valuation model for the transaction under consideration; and
applying weightings, priorities and/or probabilistic criteria to the valuation model according to criteria related to the transaction under consideration to generate a final valuation model.

The method may include the steps of extracting conceptual data from the transaction data and storing the extracted conceptual data in a sixth, concepts database, and comparing stored data from the sixth database with current conceptual data relating to a transaction under consideration, according to predetermined criteria, when generating the initial valuation model.

The method may further include the steps of storing data concerning selected valuation methodologies and techniques, and facts and rules pertaining thereto, in an expert knowledgebase, and utilising the stored data in generating the initial valuation model.

Preferably, the method comprises extracting the conceptual data from the transaction data by pattern matching, context analysis and/or concept extraction of noun phrases or concepts in the form of a “conceptual fingerprint” that characterizes similar transactions within the transaction database.

The method may include using the weightings and ratings of the determinants and the normalized values of the transactions to train algorithms in a software application of an artificial neural network by storing said weightings, ratings and normalized values in the configuration of the nodes of the network and using the application to predict the value of a new transaction.

The artificial neural network algorithms preferably compare the ratings, weightings and normalized values assigned to valuation determinants to the normalized market value of a known transaction to predict a value for a transaction under consideration.

The comparison of stored data from the second, third, fourth and fifth databases and the artificial neural network knowledgebase with current transaction data, current market value data and current financial and market data relating to a transaction under consideration is preferably carried out utilising artificial intelligence software for comparing noun phrases, concepts and/or keywords and tokens in order to search for and compare the stored data with current data relevant to the transaction under consideration.

Further according to the invention there is provided a system for valuing intellectual property, the system comprising:
a first, transaction database, comprising transaction data corresponding to a plurality of transactions relating to intellectual property;
a second, market value database, comprising data relating to normalized values extracted from the remuneration structure of specific transactions;
a third, determinants database comprising dissected and analysed data obtained by dissecting and analysing the transaction data according to a predetermined scheme;
a fourth, ratings and weightings database comprising ratings and weightings data obtained by evaluating the importance of selected determinants according to predetermined criteria;
an artificial neural network knowledgebase comprising information from the ratings and weightings database and other inputs;
a fifth, financial database comprising financial and market data extracted from the transaction data; and
a modeling and estimation module comprising an artificial neural network application arranged to compare stored data from the second, third, fourth and fifth databases and the artificial neural network knowledgebase with current transaction data, current market value data and current financial and market data relating to a transaction under consideration, according to predetermined criteria, to identify similarities between the stored data and the said current data, thereby to generate an initial valuation model for the transaction under consideration and further to apply weightings, priorities and/or probabilistic criteria to the initial valuation model according to criteria related to the transaction under consideration to generate a final valuation model.

The first, transaction database preferably contains data of transactions relating to royalty rates, license fees and intellectual property valuations or sales as well as transfers concluded as part of a sale of a business.

The weightings and ratings attached to specific transaction determinants are preferably located within the second, determinants database or in a separate database associated with the artificial neural network application.

The system may include artificial intelligence software for comparing noun phrases, concepts and/or keywords and tokens in order to search for and compare the stored data with current data relevant to the transaction under consideration.

The artificial intelligence software is preferably operable to develop intelligent agents having a learning capability that can be used to search for similarities between transactions on a conceptual level and to order transactions according to such similarities, and thus to characterize transactions by means of a “conceptual fingerprint”.

The system may include an expert system comprising a knowledge base of facts and rules pertaining to valuation methods and an associated inference engine.

The fifth, financial database preferably contains data relating to relevant economic, industry, business and market information which may influence royalty rates, license fees or the value of intellectual property.

The system may be implemented as a web service on the Internet.

### BRIEF DESCRIPTION OF THE DRAWINGS

FIG. 1 is a structural diagram showing the overall architecture of a system for determining license fees and royalty rates and for valuing intellectual property according to the invention;

FIG. 2 is a: flow diagram describing an information loading process by which new information is introduced into the system and structured into the various databases and tables within the system;

FIG. 3 is a flow diagram depicting the general valuation process carried out by the system;

FIG. 4 is a structural diagram of a general artificial neural network (ANN) with four input nodes, four hidden nodes and four output nodes and weighted interconnections between nodes;

FIG. 5 is a flow diagram depicting the mechanism by which the artificial neural network is trained to predict values according to the method of the invention;

FIG. 6 is a flow diagram depicting a search process using both conventional keyword searching and concept matching searching used in the method of the invention;

FIG. 7 is a flow diagram depicting the process of training an intelligent software agent according to the method of the invention;

FIG. 8 is a flow diagram depicting a financial analysis process according to the method of the invention;

FIG. 9 is a flow diagram depicting an expert system process and report generation process of the invention; and

FIG. 10 is a structural diagram of a network architecture and web services that can be used to implement the method and system of the invention.

### DESCRIPTION OF AN EMBODIMENT

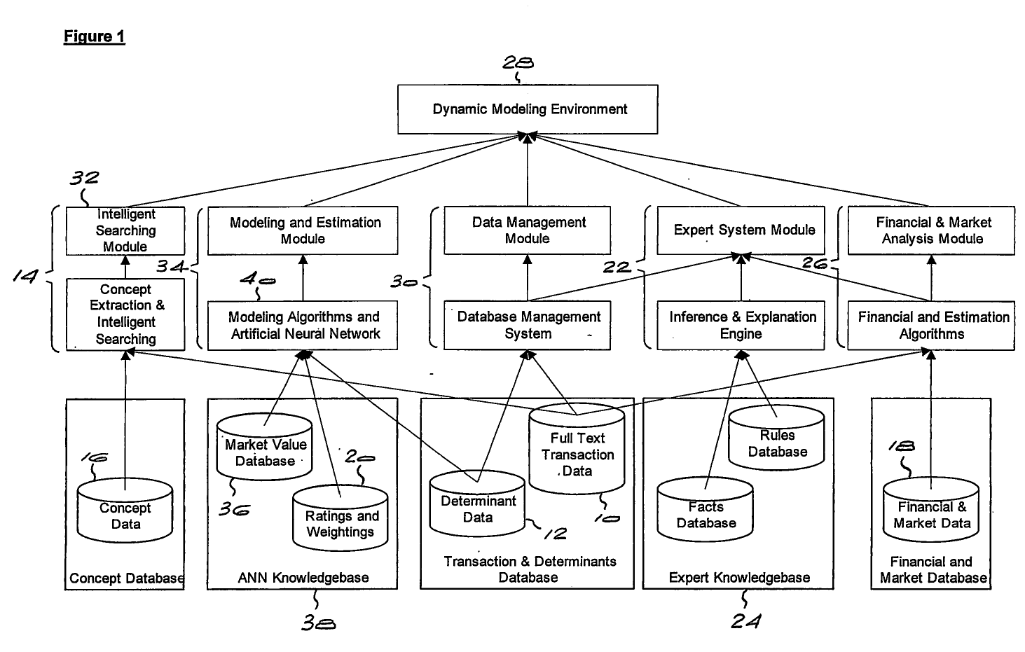

In order to perform an intellectual property (IP) valuation or calculate a license fee or royalty rate using a market-based approach to valuation, it is necessary according to the method and system of the present invention to consider the remuneration structure in previous transactions, including such forms of remuneration as upfront payments, milestone payments, license fees and royalty rates. No two transactions are exactly the same and therefore an extensive Transaction Database 10 of licensing and sale agreements is needed in order to provide sufficient comparison information in order to perform accurate valuations (see FIG. 1). In addition, the collection of data has to be carried out on an ongoing basis to ensure that the Transaction Database is kept up to date and current with respect to market trends. The information contained in the Transaction Database also needs to be dissected and analyzed according to a predetermined scheme to produce a Determinants Database 12 as having a list of undissected transaction data in a database has very little intrinsic value for the purposes of market-based valuation.

Among others, transaction data will have to be dissected into the following categories:
Into what area does the licensed IP fall; for example is it a software product, a pharmaceutical process or product, a book or an electrical gadget?
Is the licensed IP a patent, design right, trademark, copyright or know-how?
In what countries has the IP been protected? This will directly relate to the amount (monetary) that has been spent by the licensor on protection.
Is the license exclusive or non-exclusive? Is it an assignment rather than a license? Was there an option to license or no option?
Is it a license from a non-profit organization to a “for profit” organization, or a license from a “for profit” organization to a “for profit” organization or from a “for profit” organization to a “not-for-profit” organization?
In what year was the license granted?
What is the territory of the license?
What is the country of the licensor and the country of the licensee?
How are the royalty rates paid under the license (timing of)? Are there any upfront payments or milestone payments?
What is the remaining life of the IP?
Is there ongoing support from the licensor?
Are there any regulatory issues?

The above information can all be obtained from content contained in licenses/agreements and extracted from the Transaction Database 10 into the Determinants Database 12 (see below) which, when used with the software systems of the invention, can be used to calculate accurate license fees, royalty rates, and IP value. However, there are other important factors including the influence of financial, market and industry determinants that heavily influence: determinations and valuations. Other important issues include the following:
How important is the license to the licensee's business?
How does the licensed IP fit into the licensee's current portfolio of IP is it central or peripheral?
Are there competing technologies? Is it a breakthrough technology? How aggressive is research in the licensed field?
How much was spent on developing the IP to be licensed?
What is the business of the licensor and the licensee? What is the size of the licensor and size of the licensee (relates to negotiating power)?
How well developed is the IP; is it embryonic or mature?
Is there more than one potential licensee in the market? If so, how many? What is their buying power?
What are the potential markets for the licensed IP and what is their potential (maximum) size?
What is the possible number of end-user applicants for the licensed IP?

The above lists are not exhaustive and it is likely that other parameters will be important in specific industries or will become evident in time.

Information Loading

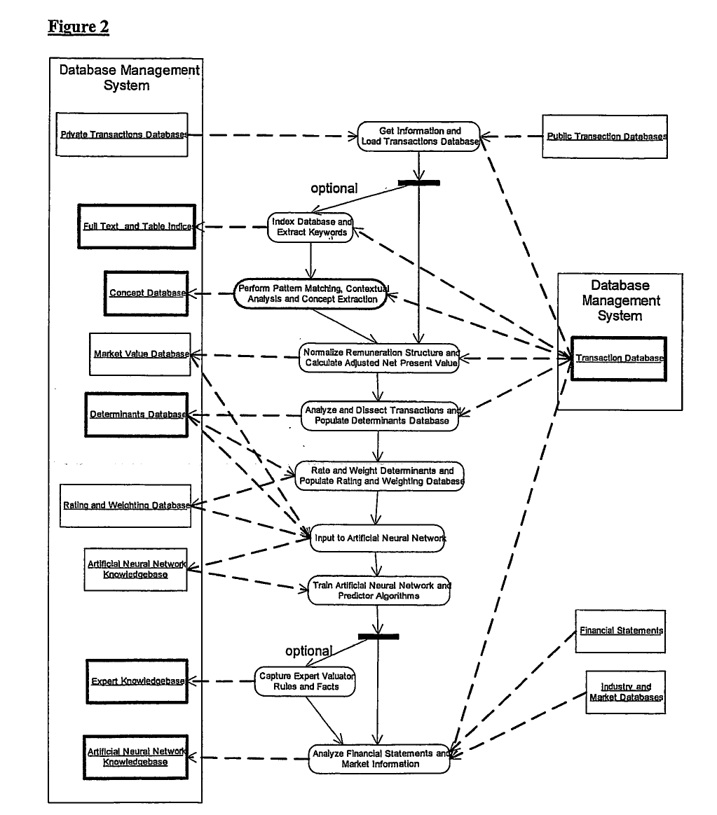

FIG. 2 details the overall process by which information is introduced into the system and the various databases comprising the information stores are loaded with data.

Licensing and sale transactions are analyzed in order to dissect the information in the Transaction Database 10 and extract relevant information into separate data structures within the Transaction and Determinants Databases. This includes extraction of license fees, royalty rates and intellectual property valuations as well as relevant keywords, either on an ad hoc basis, or according to a hierarchy of terms in a predetermined classification scheme. This structured information is stored in data structures linked to the original textual record.

In order to provide a base for market-based comparisons to permit the valuation of intellectual property using a market approach, the system of the intention starts off by compiling the above discussed Transaction Database of public and private transactions that include a license fee, royalty rate or intellectual property value. The database may either reside within the system or may be present as links to external databases. In the latter case, information from external databases can be incorporated into a main Transaction Database as and when required.

In the former situation, the system makes use of a personal computer- or server-based relational database management system that is able to provide full-text indexing, such as Microsoft SQL Server, or similar products from Oracle Corporation, IBM (DB2), or others. The database server(s) may be used to store all databases and information stores within the system according to a relational database scheme that describes and specifies the way information is structured and stored on the storage disc, or disco within the system.

The relational database management system server(s) consists of computer hardware comprising, among others, a central processing unit (CPU) lodged on a main system motherboard and communications bus, a keyboard, a cathode ray tube (CRT) display, a mouse, one or more hard disk drives for mass data storage and read/write random access memory, and software comprising, among others, a computer operating system. The relational database management system server(s) also comprises standard networking software enabling the computer server(s) to exist as part of a network of servers and workstations enabling the system to participate as part of a network of computers and to enable users to communicate with the relational database management system.

The database server(s) is connected to a standard computer network comprising, among others, a network server and network operating system, a switch or hub for sharing packets of information, and switching software. The operation of the network exits to enable workstations connected to the network to communicate with the database server(s) and use the resources deployed on the network server. In this way, many users are able to use the system and interact with the database server(s). This enables work to be shared among many workers, and the time-consuming task of collecting and collating information can be delegated to semi-skilled workers in a workflow environment.

Transactions are loaded into the Transactions Database and indexed according to specific keywords. Transactions are also classified according to industry types and according to other comparators such as technology and intellectual property type. For this purpose, standard industry classification schemes, such as the United States SIC or NAICST codes, may be used. Additional information concerning a particular transaction is stored in the database and linked to a full text record containing the entire text of the transaction, eg a licensing agreement, as well as any additional textual or other information concerning the transaction, such as spreadsheets. In addition, an optional concept matching module may be used to analyze textual descriptions of the subject of the licensing agreement in order to extract additional comparators at a higher conceptual level.

Concept Matching

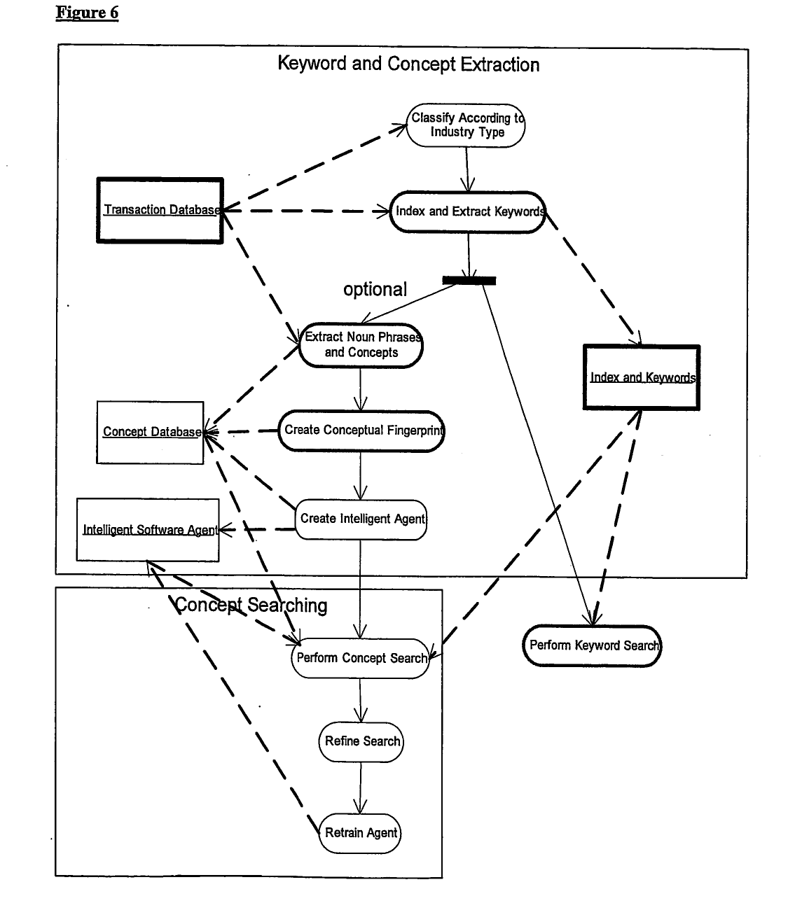

FIG. 6 details a general search process using either concept matching or generalized keyword matching.

Textual information can be analyzed using a separate artificial intelligence (AI) software application for extracting noun phrases or concepts according to a concept hierarchy, similar to that described in the Autonomy Technology White Paper (see http://www.autonomy.com). In terms of this application, a textual analyser or concept matching engine 14 is developed that uses the techniques of artificial neural network information theory and Bayesian logic to implement pattern matching, contextual analysis and concept extraction. In this way, a “conceptual fingerprint” of a record can be established and stored in a Concept Database 16 of such fingerprints.

A feedback loop can be created to refine concepts based on input derived from the use of these concepts in matching transactions and thereby providing a learning mechanism by which means the system learns the subject domain at a conceptual level. Comparing the conceptual fingerprints of transactions provides a deeper level of meaning than does comparison at the level of keywords contained in the Determinants Database 12 or terms in a classification hierarchy. Another significant advantage of the concept matching engine 14 is the fact that it is language independent. This opens up the door to including an enormous number of valid transactions stored in foreign languages and increasing the size of the Transaction Database considerably. Again, links between transactions are provided at a deeper, conceptual level.

The “conceptual fingerprint” is constructed for each transaction record in the Transaction Database 10 by objectively extracting key concepts from the text examining their relationship to one another and then comparing them to a database of topic-characteristic concepts in the Concept Database 16. The theoretical basis for compiling the conceptual fingerprint is described in the reference above. In general, Bayesian analysis is used to calculate the “a posteriori” probability distribution as a function of the known “a priori” models and likelihoods contained in a trained agent. Known techniques such as adaptive probabilistic concept modeling (APCM) are used to analyze correlation between features found in documents relevant to an agent profile, finding new concepts and documents. Concepts extracted using the above techniques are then ranked using artificial neural network information theory which details the relationship between meaning and information value. By using this with an expert system, one is able to find and reason about relationships between transactions based on objective criteria.

Users are able to implement the; system with or without the concept matching module. In this latter case, classification schemes in addition to keyword extraction will be required in order to provide links between records. At the level of a conceptual fingerprint, it is likely that far more similarities will be uncovered between transactions from disparate areas and industries. It is also necessary to load a significant amount of information into the Transaction Database 10 in order to provide the transaction volume necessary to support searching and comparison techniques. Data also needs to be kept up to date. Several public databases provide online access to data, some free.

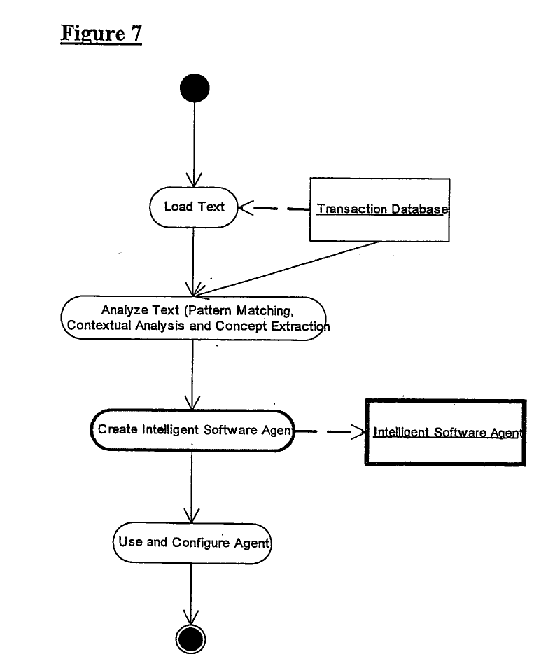

The primary use of the conceptual fingerprint is to provide a mechanism for identifying similarities between transactions, ie. to drive a sophisticated search engine. However, the Concept Database 16 of conceptual fingerprints is also used to configure intelligent agents (see FIG. 7). These agents use artificial neutral network technology to learn from “experience”. Conceptual fingerprints are used to prime and train intelligent agents in order to search and identify transactions in external databases. It is likely that the utility of the intelligent agents will extend beyond the realm of the textual databases and may also include searching and retrieving relevant financial information from industry, financial and marketing data stores (see below). It is also described below how agents can be distributed across a network between members of a collaborative team or virtual private network, particularly using a web services approach.

The main benefit of the concept matching module is to provide the user with a more sophisticated means for finding and comparing data and finding relationships between transactions that can, in turn, be used for comparison purposes.

General Market Valuation Method

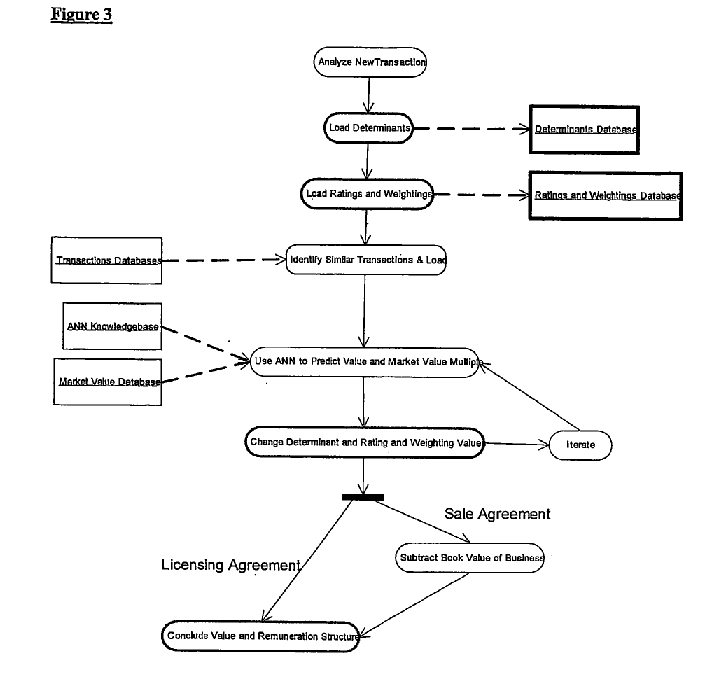

The market valuation method is generally explained by the following steps (see FIG. 3):
1. Analyse existing IP or technology transfer transactions
   1.1. Determine the normalized value of either of:
      1.1.1. the net license fee value of the intellectual property or technology; or
      1.1.2. the sale price of the intellectual property or technology; or
      1.1.3. the sale price of the business entity containing the intellectual property or intangible asset.
   1.2. Evaluate the determinants contained in the licensing or sale agreement and evaluate the rating and weighting factors associated with the determinants
   1.3. Determine the market value of the intellectual property or intangible asset and the market value multiple
2. Train the Artificial Neural Network Software Application
   2.1. Input to neural network and train algorithms
3. Determine a New Remuneration Structure
   3.1. Calculate an initial estimate of the market value from the technology and industry type and the applicable market value multiple
   3.2. Input the known values for determinants and the weightings and ratings
   3.3.1 Use the artificial neural network to predict and structure remuneration and licensing options.
      Normalized Remuneration Structure

The next step is to normalize the remuneration structure and calculate the net present value (NPV) at the valuation date, being the date that the licensing transaction was concluded. This information is input to a Market Value Database 36.

For this latter purpose, it is assumed that the agreement date is the date on which the market valuation was performed. However, this may not strictly be true and it is important for the appraiser to try and determine on what date the actual business deal was negotiated. The remuneration structure may include an upfront payment as well as interim payments which may be performance linked. The remuneration structure may also include share exchanges or other forms of remuneration. It is important that all forms of remuneration in terms of the licensing agreement are valued and included in the net value of the agreement to the licensor. Existing licensing transactions are analyzed to determine important valuation parameters and to determine the value of the remuneration structure. Details are input to a database for later application.

The following remuneration structures or combinations of remuneration structures generally are possible in a particular intellectual property or technology licensing transaction:
1. Upfront payment plus milestone (deliverable-based) and royalty (time-based) payments.
2. Upfront and royalty payments
3. Royalty payments only.
4. Outright sale of the IP or technology.
5. Outright sale of business enterprise holding the IP or technology.
6. Equity sale or exchange.

In general, the normalization of a licensing agreement remuneration structure is given by the following formula:
Remuneration Value=NPV^{(valuation date)}of Upfront Payment+NPV^{(valuation date)}(Royalty Payment×Payment Frequency×Investment Risk)+NPV^{(valuation date)}(Milestone Payment×Payment Frequency×Investment Risk)+NPV^{(valuation date)}(Market Value of Equity Exchanges)+NPV^{(valuaton date)}(Any Other Financial Consideration)

In the case where the intellectual property or technology is purchased outright, the remuneration value is simply that for an NPV^{(valuation date)} of a single upfront payment. The method and system described here also includes the case where technology is transferred as part of the sale of a business, rather than as part of a licensing agreement. In this case, conventional financial appraisal is used to determine the value of the other components of the business (eg. as described in U.S. Pat. No. 6,393,406) from financial statements and industry and market databases (see below).

In the case of a net sale of the entire business enterprise or a division of the enterprise, the value of the IP is determined from accounting values declared on the balance sheet as well as market valuation of other values, such as the shareholder's equity, using stock exchange values or market surrogates. The purchase price of the company can then be used to calculate the value of the intellectual property.

In general, the normalization of a sale agreement remuneration structure is given by the following formula:
Remuneration Value=NPV^{(valuation date)}of the ((Sale Price)−Book (Asset) Value (excluding book value of intangible assets)).

The market value of the IP or technology is calculated from the market worth and projected market share worth and adjusting for investment risk and industry parameters. Market Worth is obtained from standard market research data and market share is projected for the type of technology and business. The investment risk adjustment is calculated from standard industry curves and is a complex multiple which includes many industry- and area-specific factors, including competition from other business enterprises or potential business enterprises.

Intellectual Property value=Market Share×Market Worth×Investment Risk

The normalized remuneration value calculated, as described above, is additionally used to calculate a market value multiple for a particular industry, according to the following formula:
Market value multiple=normalized remuneration value+IP or Technology Value
Determinants Database

The Determinants Database 12 is a core component of the system that is used to capture all the factors contained within a licensing agreement that affect the value of the agreement and the remuneration structure agreed between the parties. A list of initial valuation determinants is detailed in Table 1 below. These are general determinants used to capture, in general terms, the valuation parameters; influencing the value. Additional determinants can be added for specific industries and intellectual property types.

Table 1—List of Initial Valuation Determinants
1. All the territories in which the product or technology is licensed
2. The exclusivity of the agreement (Exclusive, Sole or Non-Exclusive)
3. The term of the agreement (number of years or perpetual)
4. The remaining life of the legal protection at the date of the agreement
5. Details of any restrictions on the license eg no sub-license or transfer
6. The general area in which the technology falls, eg biotechnology, Engineering
7. A brief description of the technology that is the subject of the licensing agreement
8. Any regulatory approval required to fully exploit the technology
9. The type of any legal protection afforded to the IP
10. The support provide by the Licensor for infringement
11. Ongoing support provided by the Licensor as part of the licensing agreement
12. Details of any other IP, know-how or confidential information transfers between Licensor and Licensee in the agreement
13. The amount and currency of any upfront payment
14. The amount, currency, frequency and duration of any milestone payments as well as details of the trigger event
15. The amount, currency, frequency and duration of any royalty payments.
16. The amount and worth of any share exchanges and Licensor Licensee
17. The value of any sale agreement concluded as part of the technology or IP exchange
18. Is the Licensor listed on a public exchange?
19. Is the Licensee listed on a public exchange?
20. The strength of the legal protection
21. The degree of enforceability of the legal protection
22. How much the Licensee's IP portfolio will increase in value due to addition of the licensed IP or technology
23. The goodness of fit between the licensed technology and the Licensee's existing IP portfolio
24. Any existing business relationship (excluding technology transfer) between Licensor and Licensee
25. Details of any previous technology, IP or confidential information transfers between Licensor and Licensee & relation to present agreement
26. The degree of maturity of the technology, ranging from embryonic to mature
27. The cost of bringing the IP or technology to market
28. The potential competition measured in terms of organisations or individuals competing with the licensed technology
29. The rate that the technology in the technological area is advancing, ranging from pedestrian to very fast
30. Competitive technology or IP in the markets prior to the date of licensing the technology
31. The extent of improvement of the licensed technology on any existing technology
32. The degree of innovation, ranging from improvement to a breakthrough
33. Other technologies required to fully utilize the licensed technology (1f not usable on its own)
34. Ownership of improvements
35. Responsibility for maintenance of patents.

The Determinants Database 12 contains mainly factual information that can be gleaned from existing or new transactions by semi-skilled people, familiar with the general procedure. This facilitates the overall workflow in an appraisal office and results in an effective division of labor.

A major advantage of the method of dissecting transactions into determinants in the Determinants Database 12 is that it effectively “anonymizes” (ie. renders anonymous) the transaction data. This is particularly important in view of the confidential nature of the vast majority of licensing transactions and sale agreements for transferring intellectual property and intangible assets. The salient information contained in a particular transaction which is pertinent to a market valuation can be stored and used separately from information that identifies the parties to the agreement and other identifying details of the agreement. This means that potentially vast quantities of information can be used for comparison purposes by the artificial neural network while guaranteeing the anonymity of the agreement.

Anonymity is an important feature of this method as it provides a mechanism by which large quantities of data can be integrated for comparison purposes and overcomes one of the main drawbacks of the market valuation approach which is the lack of sufficient amounts of transaction data for proper comparison purposes.

The process of populating the Determinants Database 12 according to the above list of determinants and other determinants which may be added, proceeds by examining the licensing or sale agreement and copying or entering information into the specific predetermined fields in the Determinants Database. This information, together with expert input, is used to produce a numerical rating and weighting, as described below.

Rating and Weighting

In the embodiment described here, existing transactions in the Transactions Database 10 and determinants in the Determinants Database 12 are analyzed by skilled appraisers and valuation professionals to determine the relative importance of the particular determinant in determining the value of the transaction. While the processes of normalizing the remuneration structure and populating the Determinants Database may be carried out by semi-skilled persons with some knowledge of the problem domain, the rating and weighting of particular valuation determinants needs to be done by a skilled valuation professional or appraiser.

The rating and weighting process proceeds by examining transaction information in the Transactions Database and determinants information in the Determinants Database and evaluating the relative importance to the transaction in question, in particular, the value as reflected in the normalized remuneration structure agreed to by the parties. The rating factor generally proceeds by assigning a numerical score on a sliding scale of values between a lower and an upper bound. The score assigned to the particular transaction in question is an assessment provided by a skilled valuation professional or appraiser of the relative importance of the particular term in the licensing or sale agreement comparison with other, similar transactions within the industry area, based on objective criteria.

The weighting factor assigned to a particular determinant is a numerical score assigned by a skilled valuation professional or appraiser that reflects the relative importance of the determinant in affecting the normalized value for the transaction in question, based on personal experience and professional judgment. The weighting factor will depend on several other criteria, such as the particular industry type, and is used to individually tailor the determinants for any one transaction. The rating and weighting assigned to a particular determinant will vary between industry and tecnnoiogy types and will need to be assigned on an individual transaction basis.

The ratings and weightings assigned to transaction determinants are an important part of the method and system as they provides the basis for the artificial neural network application, described below. In addition, the assignment of ratings and weightings is an important knowledge management aspect of the method and system as it provides a mechanism for capturing some of the skill and knowledge retained by valuation professionals and appraisers and can be used both to mentor other workers as well as to provide some continuity in the event that such a person is no longer available. The construction of an expert system knowledgebase, described below, is another means of providing this form of knowledge management.

Artificial Neural Network Application

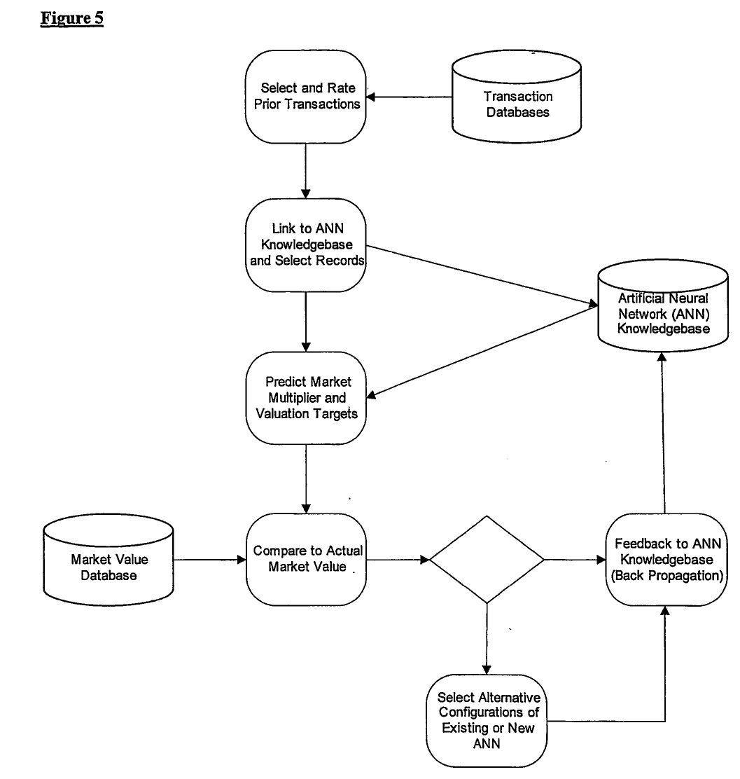

FIG. 5 depicts the general process by which the artificial neural network application is used to predict values.

The information contained in the Market Valuation, Determinants and the Weighting and Rating Databases 18, 12 and 20 are input to an artificial neural network knowledgebase 38 which, in turn is used to train the artificial neural network algorithms and application. The knowledgebase may comprise a physical database structure or may be a logical database structure contained within one or more other databases or links to such other databases. The same algorithms and artificial neural network application may additionally be used to train the intelligent agents, described above.

The normalized value and market value multiple are input to the artificial neural network software application 40 along with the parameters extracted from the licensing agreement. These are then used to train the artificial neural network to predict a new value for a defined intellectual property or technology. In addition, the artificial neural network can assist in determining the structure of the licensing agreement and remuneration package.

Each new transaction that is input to and processed by the artificial neural network, in turn, is added to the Artificial Neural Network knowledgebase 38 and can then be used to configure the network and can then be selected as input for other new transactions.

The behavior of the individual parameters is stored within individual “neurons” within the network and described by mathematical functions. The predictive ability is stored within the structure and configuration of the “neurons” making up the artificial neural network and the type of optimising behavior programmed into the network.

A theoretical adjusted normalized value can be calculated from the normalized value which is adjusted according to the agreement determinants, although this measure my have no real value meaning in absolute terms.
Adjusted Net License Fee Value=Net License Value=(Agreement Determinants)

Artificial neural networks are software constructs modeled on the functioning of the human brain. The artificial neural network software application comprises a system of nodes, connected by links, each of which has a numerical weight associated with it. The weights represent the long-term storage of the network and learning occurs by updating the weighting factors connecting nodes in the network. Each node has a set of input links from other units, a set of output links to other units, a current activation level and a means of computing the activation level at every step in time. The weights in the network are initialized with some default value and then synchronously updated based on inputs over time. Each node receives input from its input links and performs a computation based on the values of the input signal received from each neighbouring node and the value of the weight on the respective input link. It then performs a linear input function to compute the weighted sum of the node's input values followed by a non-linear activation function that transforms the weighted sum into the final value that serves as the node's activation value. Neural networks can be classified into two main types, feed-forward and recurrent networks, and there are also several different subtypes. These different networks have different features and may be more or less appropriate for different problems. The optimal network structure may be found by employing searching and learning techniques such as hill-climbing, simulated annealing or genetic algorithms. It is a common practice to vary the network type and the parameters of the weighting and activation functions contained in the nodes and links during the early stages of problem solving in order to evolve a network structure that works well for a particular problem domain.

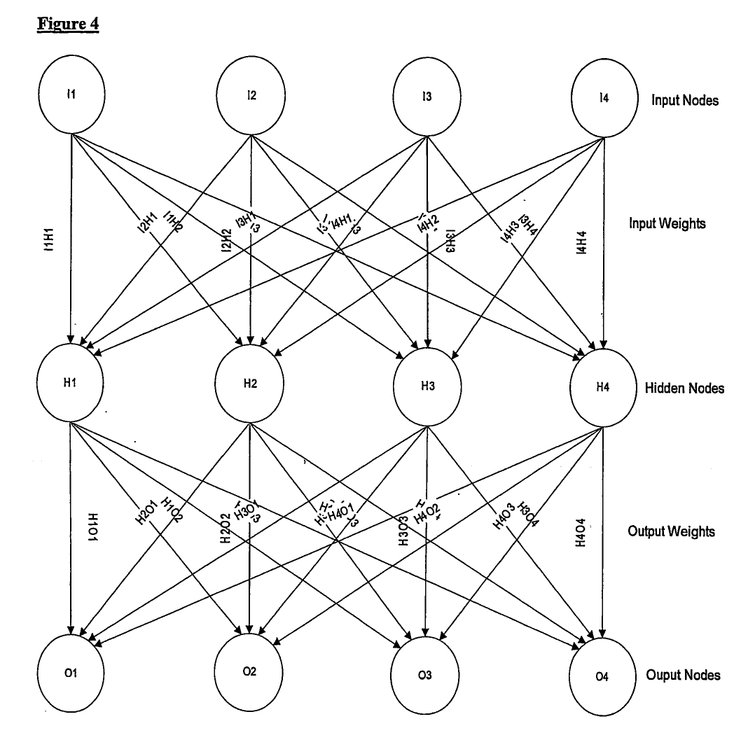

In the present embodiment, the most likely network topology comprises a multi-layer feed-forward network in which there are three principle layers in the network, an input layer to receive input from the environment, an output layer to produce outputs and, in between, a layer of hidden nodes that connect nodes from the input layer to nodes in the output layer. In this specific configuration, illustrated in FIG. 4, the evolution of weights and consequent learning by the system can be driven by a technique known as back-propagation.

The learning potential of the system applied to the artificial neural network is supplemented by a system of probabilistic learning using Bayesian learning, as discussed above. In the present embodiment, this technique is particularly useful for representing and reasoning with uncertain knowledge and the associated probabilities. Networks equipped with these kinds of learning characteristics are generally referred to as adaptive probabilistic networks.

In the present embodiment, a commercial artificial neural network software application can be purchased or, alternatively, a purpose-built application could be developed. In either case, it will be necessary to select appropriate algorithms from preexisting types and to configure the internal structure to suit the purpose. The network structure and the characteristics and parameters of the various algorithms and functions in the nodes, links and other components of the network must be evolved so as to optimally retain the knowledge contained in dissected licensing and sale agreements and accurately predict a fair value based on prior transactions.

In its simplest manifestation, the nodes of the artificial neural network will correspond directly to the valuation determinants, the links to the relationships that exist between determinants and the weighting on the links to the ratings and weightings assigned to the determinants. Actual and predicted normalized values are used as goals and feedback into the system, driving the learning function.

It is an important feature of the system that the feedback mechanism for the artificial neural network learning algorithms is provided by “done deals”. It is generally assumed that these provide the most accurate estimation of the fair value of the particular transaction as they are the result of an arms length business negotiation process involving two parties with self-interest. Therefore, the task of the system is reduced to accurately storing this information bringing it to bear on the transaction at hand while normalizing and correcting for other factors influencing the normalized value whilst maintaining the normalized remuneration or value as a constant.

Structuring a New Licensing or Sale Agreement

The ANN software application 40 is used to predict a new license fee and structure and agreement in two steps. Firstly, the market value of the new intellectual property or technology to be transferred is determined from market research data. The industry type (SIC or NAICST code) of the new intellectual property or technology and the market value of the new intellectual property or technology are input to the artificial neural network software application and are used to predict the market value multiple and normalized remuneration or value. In the second step, the artificial neural network software application is used to structure different remuneration packages by varying valuation determinants and solving for others.

Expert Valuation System

Another optional aspect of the system and method of the invention is the implementation of an expert system application to assist and guide users in performing valuations and also to provide an audit trail of decisions made in arriving at a particular valuation.

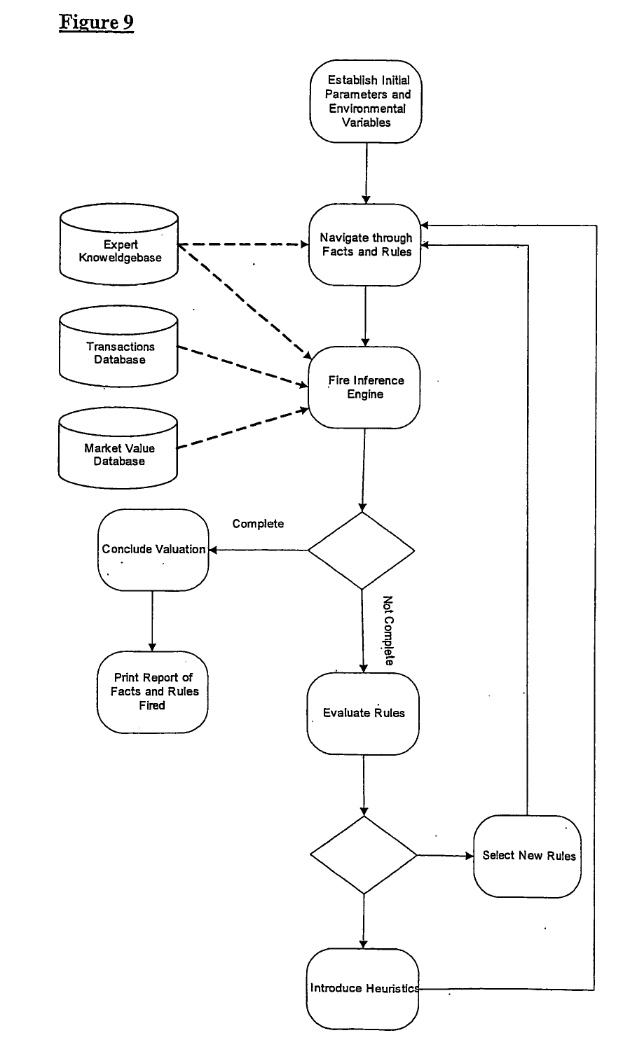

An Expert System Module 22 is included in order to provide a dynamic environment for executing rules-based inference and guiding the user through the process of navigating the facts and rules (see FIG. 9). In addition, the expert system provides an opportunity to alter the weighting of different parameters and to introduce heuristic considerations from experience or external information. The expert system also provides an explanation feature and audit trail of all the factors leading to a final conclusion. This is an important part of the process that can provide valuable information for the purposes of evidence or simply a learning experience for a novice user. In addition, it can be used to assist in developing a standard for performing such calculations. As contemplated in the present embodiment, by generating an auditable account of a valuation process, the system will stimulate a whole industry where valuations are based on precedent rather than simply on common accounting practices. This is relevant both within a legal environment as well as for other kinds of valuations. For example, it is common knowledge that banks miss out on significant investment opportunities as a result of an inability to correctly appraise the value of new businesses whose main assets are intangible, particularly intellectual property. The expert system also forms an integral part of the Dynamic Modeling Environment, described below, by applying constraints and warnings during modeling and drives the production of the final report that includes the license fee, royalty rate or IP valuation as well as the audit trial of inferences and rules leading to the final result.

In the present embodiment, the expert system comprises a knowledgebase 24 of facts and rules concerning common valuation and licensing practices combined with an inference engine that is able to reason and deduce using the knowledgebase as input for a defined goal. The process of populating the knowledgebase is carried out by a specialist computer software engineer with knowledge of the problem domain, referred to as a knowledge engineer, who obtains knowledge concerning these practices from valuation professionals and appraisers and codifies them in a suitable computer software language representation, making up the facts and rules. It is common practice to employ a commercial inference engine that comprises standard inference mechanisms.

The expert system module also optionally offers case-based reasoning as an alternative means for structuring the knowledge contained in the system and inferring solutions. When using this method, the user, while interacting with the system, retrieves a case (transaction in this system) that is similar to the new case (transaction) under consideration. The system then adapts the case (transaction) using any one of several different schemes, such as goal lists.

Financial and Market Analysis

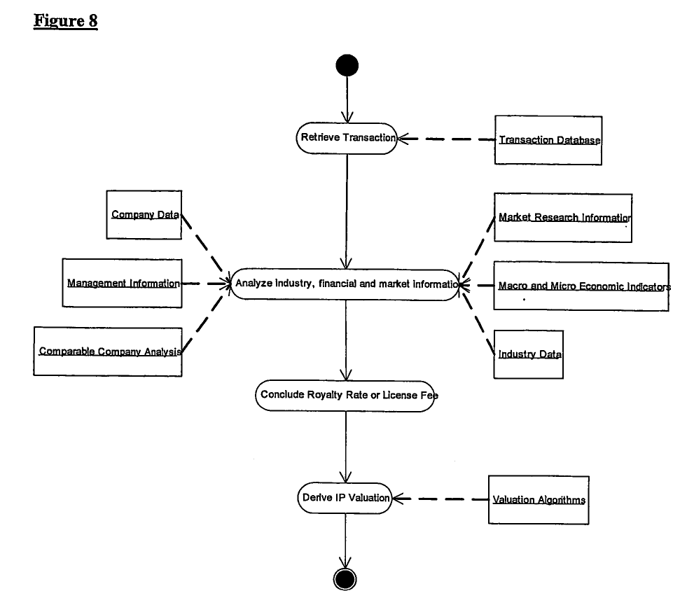

As discussed above, license fees, royalty rates and intellectual property values are critically dependent on the business in which they reside. Therefore, the system provides a sophisticated Financial and Market Database 18 of business, financial, marketing and industry information as well as a suite of financial algorithms for computing values (see FIG. 8). As with the Transaction Database, described above, this information may either be stored within the system or externally via links to the wealth of public and private online services that are available on the Internet and through third party information providers, like America Online. In certain situations, it may be useful to apply the concept matching engine to this information to extract profiles of industries but, more generally, the information is extracted in the form of financial indicators that can be used to weight values computed within the system.

A corresponding Financial and Market Analysis Module 26 can also be used to carry out a financial analysis of transactions in order to normalize transactions from different industries so as to better compare license fees, royalty rates or intellectual property values embedded in different businesses or industries. In addition, the financial module is used to carry out conventional financial analysis of transactions according to cost or income approaches for comparison purposes. This information and functionality can either be used as a standalone function, or it can be used by the Expert System Module 22 (see above) or it can be imported into a Dynamic Modeling Environment for comparative purposes (see below).

The market information contained with the Financial and Market Database 18 is also used to calculate market value multiples and objective assessments of intellectual property worth, based on market forces. The database also contain common market heuristics, along the lines of “ . . . it is usual to receive a royalty rate of x% in market y . . . ”. These heuristic are additionally important and useful within the optional Expert Systems Module 22.

The market information also includes share prices for relevant businesses as quoted by specific share exchanges and the historic and time-dependent performance of these shares. This information is used to obtain a market value for businesses where the intellectual property is transferred as part of a business. In addition, it can also be used to indirectly infer the relative effect of a particular licensing or sale transaction on the share prices of the respective licensor (purchaser) and licensee (purchasee) and provide a measure of the success and monetary worth of the transfer.

Dynamic Modeling Environment A Dynamic Modeling Environment 28 is provided at the highest level of functionality to provide an opportunity for the user to experiment with different parameters in order to improve the assessment and to compare results obtained using different valuation approaches. The modeling environment generally includes all of the functionality discussed above, except where a user elects to exclude certain (expensive) functionality, such as the Concept Matching Engine 14. The modeling environment is a graphical user interface linking other functionality and introducing certain additional AI functionality to help predict the outcomes of certain changes to the system.

The graphical user environment makes use of common windowing software applications developed using software such as Visual Studio .Net (Microsoft Corporation) or Java (Sun Microsystems). Specific areas of functionality are confined to a window and several windows can be opened at once and alternatively displayed or hidden. Information can be easily dragged from one window and dropped into another. This software feature enables the user to call into main system memory several processes at once to compare and switch information.

Using the windowing system provided by the Dynamic Modeling Environment, the user is able to invoke different features of the software application and modules in order to try and converge on a solution. The software acts as an intelligent assistant that permits the user to conveniently display different aspects of a potential solution and compare values. Typically, the user will iterate through a succession of techniques and refinements until a solution is found that satisfies most of the system constraints and is intuitively correct. For example, an assistant may start off in the Expert System Module 22 in order to find a relevant case (transaction) and thereafter, obtain normalized value before setting determinants an examining the effects of varying the determinants according to the known constraints of the particular situation.

The Dynamic Modeling Environment also provides the user with an opportunity to use different valuation methodologies for different situations. Although the present system is predominantly geared towards a market approach using comparisons between arms length transactions, income and cost-based approaches can also be included and used within the system. These latter approaches can be used both to perform de novo valuations of new transactions or they can be used to analyze existing transactions that were originally performed using an income or cost-based approach.

Network and Internet Portal

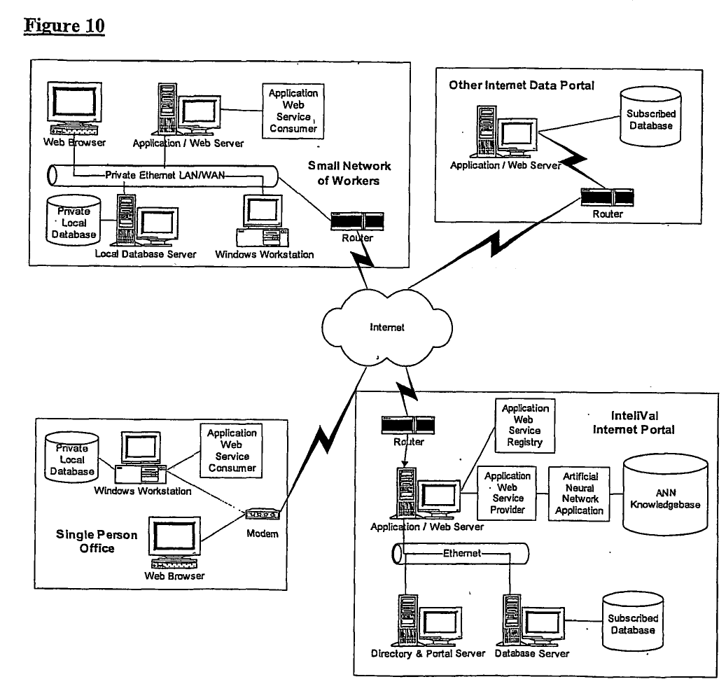

The system can function either on a single computer (of a particular type) or on a server and typically requires at least a database management server(s) (as described above) and an Internet web server, such as Microsoft Internet Information Server (see FIG. 10). In this latter configuration, the system will typically also contain an application server. The system may also be purchased in modular fashion and be deployed in whole pr part through an Internet portal, such as Microsoft Sharepoint Portal Server or Netscape Compass Server. The system integrates with other common software and collaborative products, such as Microsoft Office and BackOffice.

As a result of this integration, the system can be deployed either as a standalone system or as part of a network of connected users and users may acquire only the modules they require. Integration with other collaborative tools is an important feature of the system that will be attractive to the larger offices as it provides an opportunity for workflow to be implemented in the valuation process and for work to be apportioned between assistants and valuation professionals. In addition, valuation professionals are able to collaborate on difficult cases and compare valuations performed by different valuation professionals on the same transaction as well as in maximizing the use of internal resources, such as proprietary database information. Organizations with significant information resources are able to grant access to approved partners or to rent out access to their resources on a subscription or per transaction basis. A licensed organization is also able to run an Internet portal, as described below.

Portal Web Service

According to the present system and method, the application may also be deployed as a web service using standard internet protocols, as depicted in FIG. 10. This is an important mechanism for enabling confidential data sharing among users. In terms of this method, transaction data is stored confidentially in a private database for private use but the Determinants extracted from this data and stored in the Determinants Database 12 is made available to other users as a standard web service. This enables the common pool of transaction information that can be shared to be increased significantly and for data to be shared among firms with the common interest of raising the standard and comparability of intellectual property valuations.

According to this method, data is stored in the format of the eXtensible Markup Language (XML) and methods for using and accessing the data are deployed using the Simple Object Access Protocol (SOAP). The mechanism for accessing the data is specified and published by the data provider using the Web Services Definition Language (WSDL). A universal registry, of methods and locations of data and methods is stored and published using the Universal Description, Definition and Integration Protocol (UDDI) protocol.

Applications deployed as web services can be distributed across private and public networks such as the Internet and are transparent to normal security features such as firewalls as they use the standard Internet, Hypertext Transfer Protocol (HTTP) for communication. Web services are easily programmed using modem development tools such as Visual Studio .Net (Microsoft Corporation) or Java technology (Sun Microsystems) and application servers such as WebSphere (IBM) or WebLogic (BEA Systems). Web services may also be deployed using secure techniques, such as public and private key encryption and secure hypertext transfer protocol (HTTPS).

According to the web service architecture, specific software applications are deployed to host computers were they expose methods for data access or functionality to other potential users connected via the protocols detailed above. A registry of methods is hosted on one or more other computers connected t the network. Approved clients, or service consumers, requiring data or services connect to the registry to locate a potential service or data provider(s).

According to the method and system detailed here, this comprises either determinant and valuation data that could be relevant to the present search or functionality that the client does not have. The service provision could also be provided free-of-charge or via some other system for exacting payment. Once a potential service or data provider(s) has been located, the client then connects to the provider(s) using a standard published interface and either uses the service or obtains the data. Service or data providers would typically subscribe to a central data sharing scheme and share determinant data in this way. Service providers might also share processes for assisting with a valuation in this way, subject to software licensing constraints.

In addition to the benefits that this system has for distributing data and applications across networks, there is an additional benefit from a data storage perspective. Transaction data comprises large tracts of text and requires specialist database management systems to store and index these transaction texts. It is generally beyond the scope of any one organization to store all of this information in one place as well as to keep the documentation indexed and up to date. The distributed model makes the data storage much more efficient and also places the responsibility for keeping records up to date with the people who know the data best while allowing restricted and secure access to others for the purposes of information sharing.

The method and computer-implemented system of the present invention may be used to provide accurate royalty rates and license fees or derive IP values for a new transaction or object of IP, as the case may be, or to appraise the validity of existing royalty rates, license fees or IP values. The audit and explanation function of one of the subsystems provides a mechanism for justifying the values derived.

The system is primarily targeted at skilled professionals and semi-skilled assistants who perform valuations almost on a daily basis. However, the system may also be usable by untrained persons with some knowledge of general financial principles and the assumptions required to perform a particular valuation. A major benefit will be the fact that any authorized user will be able to log on and search the database for transactions on which a first estimate can be based.

The structural diagram of FIG. 1 shows the overall architecture of the system and the structure of the major subsystems. Users will typically interact with the system through the overall system interface (Dynamic Modeling Environment 28). Most users will acquire a Data Management Module 30 with or without the Concept Matching Module 14. In this latter case, users will typically create hierarchies for classifying transactions in the database and use these schemes in addition to keyword matches for establishing relationships between transactions. This will typically be supplemented with information from the Financial and Market Analysis Module 26. In fact users at this level may wish to use cost and income approaches as the primary mechanism for arriving at a value and use the transact on system to provide some supporting evidence from the market approach.

Where the user deploys the Concept Matching Module 14 within the system, all transactions will need to be analysed and the conceptual fingerprint stored within the Concept Database 16. External information can also be “fingerprinted” as long as access is allowed. Users with the Concept Matching Module 14 will typically develop a whole library of conceptual fingerprints for the purposes of searching and concept matching.

The artificial neural network 40 is included in a Modeling and Estimation Module 34.

FIG. 2 depicts the detailed process by which information is loaded into the system.

Most users deploying the Concept Matching Module 14 will also use an Intelligent Software Agent module 32 as well. An intelligent agent can be configured with the information from a particular, say a new, transaction, particularly conceptual information and can then be used as a search tool.

The Financial and Market Analysis Module 26 will also be essential for most users. It provides both the mechanism for deriving values based on the cost and income approaches as well as the algorithms supporting much of the calculation and adjustment that needs to occur. Users may use this Module alone where the cost or income approach is preferred.

The Expert System Module 22 is appropriate both for novice and sophisticated users. In the case of novice users, the expert system is typically used to assist with the process of calculating a license fee, royalty rate or IP valuation. A wizard-driven interface guides the user through the information requirements to perform the calculations and also an explanation of the derivation process. Experienced users will interact with the expert system in a more sophisticated way and will use it to determine the effect of applying different weightings and heuristic considerations to arrive at a final valuation and also to introduce probabilistic reasoning where information is lacking.

A valuation report is an essential product of the system and presents the results from the different Modules.

FIG. 10 depicts the four typical computer configurations that will be used to support the system. In the first case, standalone computers will be used by single users to run the system and will contain all necessary information in databases stored in a local database management system. Small offices will deploy the system on a single local area network with centralized database and application servers that can be accessed by other clients on the network. In the third case, the application will be deployed as part of a large wide area network with distributed information stores and applications. These users will typically employ other collaborative tools, as discussed above, in order to promote interoperation between skilled professionals. Information stores may be distributed with local access to local information. Lastly, the system can be deployed within an Internet (or intranet/extranet) portal with restricted access, or on a charge-out basis. In the main, the distributed application will be developed according to a web services model, as described above, which will enable the application to be configured to run either in a standalone mode or in a distributed mode, partitioned across different application and database servers and networks.

1. A method of valuing intellectual property, the method comprising:
compiling a first, transaction database of transaction data corresponding to a plurality of transactions relating to intellectual property;
normalizing the remuneration structure of specific transactions in order to extract normalized values thereof and storing said values in a second, market value database;
dissecting and analysing the transaction data according to a predetermined scheme and storing the dissected and analysed data in a third, determinants database;
evaluating the importance of selected determinants according to predetermined criteria to obtain ratings and weightings corresponding thereto, and storing the ratings and weightings in a fourth, ratings and weightings database;
compiling an artificial neural network knowledgebase using information from the ratings and weightings database and other inputs;
extracting financial and market data from the transaction data and storing the extracted financial and market data in a fifth, financial database;
comparing stored data from the second, third, fourth and fifth databases and the artificial neural network knowledgebase with current transaction data, current market value data, and current financial and market data relating to a transaction under consideration, according to predetermined criteria, to identify similarities between the stored data and the said current data, thereby to generate an initial valuation model for the transaction under consideration; and
applying weightings, priorities and/or probabilistic criteria to the valuation model according to criteria related to the transaction under consideration to generate a final valuation model.

2. A method according to claim 1 including the steps of extracting conceptual data from the transaction data and storing the extracted conceptual data in a sixth, concepts database, and comparing stored data from the sixth database with current conceptual data relating to a transaction under consideration, according to predetermined criteria, when generating the initial valuation model.

3. IA method according to claim 1 or claim 2 including the steps of storing data concerning selected valuation methodologies and techniques and facts and rules pertaining thereto, in an expert knowledgebase, and utilising the stored data in generating the initial valuation model.

4. A method according to claim 2 comprising extracting the conceptual data from the transaction data by pattern matching, context analysis and/or concept extraction of noun phrases or concepts in the form of a “conceptual fingerprint” that characterizes similar transactions within the transaction database.

5. A method according to any one of claims 1 to 4 including using the weightings and ratings of the determinants and the normalized values of, the transactions to train algorithms in a software application of an artificial neural network by storing said weightings, ratings and normalized values in the configuration of the nodes of the network and using the application to predict the value of a new transaction.

6. A method according to claim 5 wherein the artificial neural network algorithms compare the ratings, weightings and normalized values assigned to valuation determinants to the normalized market value of a known transaction to predict a value for a transaction under consideration.

7. IA method according to any one of claims 1 to 6 wherein the comparison of stored data from the second, third, fourth and fifth databases and the artificial neural network knowledgebase with current transaction data, current market value data and current financial and market data relating to a transaction under consideration is carried out utilising artificial intelligence software for comparing noun phrases, concepts and/or keywords and tokens in order to search for and compare the stored data with current data relevant to the transaction under consideration.

8. A system for valuing intellectual property, the system comprising:
a first, transaction database, comprising transaction data corresponding to a plurality of transactions relating to intellectual property;
a second, market value database, comprising data relating to normalized values extracted from the remuneration structure of specific transactions;
a third, determinants database comprising dissected and analysed data obtained by dissecting and analysing the transaction data according to a predetermined scheme;
a fourth, weightings and ratings database comprising weightings and ratings data obtained by evaluating the importance of selected determinants according to predetermined criteria;
an artificial neural network knowledgebase comprising information from the ratings and weightings database and other inputs;
a fifth, financial database comprising financial and market data extracted from the transaction data; and
a modeling and estimation module comprising an artificial neural network application arranged to compare stored data from the second, third, fourth and fifth databases and the artificial neural network knowledgebase with current transaction data, current market value data and current financial and market data relating to a transaction under consideration, according to predetermined criteria, to identify similarities between the stored data and the said current data, thereby to generate an initial valuation model for the transaction under consideration and further to apply weightings, ratings, priorities and/or probabilistic criteria to the initial valuation model according to criteria related to the transaction under consideration to generate a final valuation model.

9. A system according to claim 8 wherein the first, transaction database contains data of transactions relating to royalty rates, license fees and intellectual property valuations or sales as well as transfers concluded as part of a sale of a business.

10. A system according to claim 8 or claim 9 wherein the weightings and ratings attached to specific transaction determinants are located within the second, determinants database or in a separate database associated with the artificial neural network application.

11. A system according to any one of claims 8 to 10 including artificial intelligence software for comparing noun phrases, concepts and/or keywords and tokens in order to search for and compare the stored data with current data relevant to the transaction under consideration.

12. A system according to claim 11 wherein the artificial intelligence software is operable to develop intelligent agents having a learning capability that can be used to search for similarities between transactions on a conceptual level and to order transactions according to such similarities, and thus to characterize transactions by means of a “conceptual fingerprint”.

13. A system according to any one of claims 8 to 12 including an expert system comprising a knowledge base of facts and rules pertaining to valuation methods and an associated inference engine.

14. A system according to any one of claims 8 to 12 wherein the fifth, financial database contains data relating to relevant economic, industry, business and market information which may influence royalty rates, license fees or the value of intellectual property.

15. A system according to any one of claims 8 to 14 which is implemented as a web service on the Internet.
